(19) United States
(12) Patent Application Publication
(10) Pub. No.: US 2015/0193774 A1
(43) Pub. Date: Jul. 9, 2015

(54) SYSTEM AND METHOD FOR FRAUD DETECTION USING SOCIAL MEDIA

(71) Applicant: Capital One Financial Corporation, McLean, VA (US)

(72) Inventor: Christopher WETZEL, Wayne, PA (US)

(21) Appl. No.: 14/592,295

(22) Filed: Jan. 8, 2015

Related U.S. Application Data
(60) Provisional application No. 61/924,727, filed on Jan. 8, 2014.

(51) Int. Cl. G06Q 20/40; G06Q 50/00

(52) U.S. Cl. CPC G06Q 20/4016; G06Q 50/01

(57) ABSTRACT

Systems and methods for fraud detection include an application programming interface (API) that establishes, via a network, a link between an account provider system and a social media system, a registration processor that receives, via a network, registration information that indicates that a customer wishes to register for a location-based account service provided by the account provider system, wherein the social media system provides at least a portion of location data used to support the location-based account service provided by the account provider system, a location processor that receives, via a network, location information from the social media system, wherein the location information is associated with the location of the customer, and a fraud processor that executes a fraud detection algorithm to determine whether to approve a transaction based in part on the received location information.

### CROSS-REFERENCE TO RELATED APPLICATIONS

This application contains subject matter related to U.S. Provisional Patent Application No. 61/924,727, filed Jan. 8, 2014, the entire contents of which is incorporated herein by reference. This application also contains subject matter related to U.S. patent application Ser. No. 14/031,263 entitled “System and Method for Determining Social Statements,” and U.S. Provisional Patent Application No. 61/737,399 entitled “System and Method for Synching a Financial Account with a Social Network Account,” U.S. Provisional Patent Application No. 61/789,858 entitled “System and Method for Fraud Management,” and U.S. Pat. No. 7,857,212, entitled “Method and system for authorizing card account transactions by geographic region,” the contents of which are incorporated by reference in their entirety.

### FIELD OF THE DISCLOSURE

The present disclosure relates to a system and method for fraud detection using social media systems and data, including various features provided by mobile devices executing social media applications.

### BACKGROUND OF THE DISCLOSURE

Fraud detection systems and methods may utilize various tools in order to prevent fraudulent account use. Currently, when a customer anticipates traveling, the customer may contact the account provider to inform the account provider of upcoming travel plans so that fraud triggers may be removed and the customer may use the account while traveling. Should a customer forget to contact the account provider, the account provider may receive an authorization request from a location not associated with the account and automatically put a hold on the account and/or cancel all transaction cards associated with the account. These and other drawbacks exist.

### SUMMARY OF DISCLOSURE

According to the various embodiments of the present disclosure, a system and method of fraud detection using social media may include receiving an account holder's social media information, linking the account holder's social media information with accounts held by the account holder at the account provider, receiving location information from the linked social media account, and deactivating fraud triggers based on the location information to allow the account holder to use any account holder transaction card.

According to the various embodiments, a system for fraud detection include an application programming interface (API) that establishes, via a network, a link between an account provider system and a social media system, a registration processor that receives, via a network, registration information that indicates that a customer wishes to register for a location-based account service provided by the account provider system, wherein the social media system provides at least a portion of location data used to support the location-based account service provided by the account provider system, a location processor that receives, via a network, location information from the social media system, wherein the location information is associated with the location of the customer, and a fraud processor that executes a fraud detection algorithm to determine whether to approve a transaction based in part on the received location information.

According to the various embodiments, a method for fraud detection includes establishing, via a network using an application programming interface (API), a link between an account provider system and a social media system, receiving, via a network using a registration processor, registration information that indicates that a customer wishes to register for a location-based account service provided by the account provider system, wherein the social media system provides at least a portion of location data used to support the location-based account service provided by the account provider system, receiving, via a network using a location processor, location information from the social media system, wherein the location information is associated with the location of the customer, and executing, using a fraud processor, a fraud detection algorithm to determine whether to approve a transaction based in part on the received location information.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 depicts an example embodiment of a system for fraud detection using social media according to an embodiment of the disclosure;

FIG. 1A depicts an example embodiment of a system for fraud detection using social media according to an embodiment of the disclosure;

FIG. 2 depicts an example embodiment of system components for fraud detection using social media according to an embodiment of the disclosure;

FIG. 3 depicts an example flow chart illustrating a method for fraud detection using social media according to an embodiment of the disclosure;

FIG. 4 depicts an example embodiment of an authorization network associated with a system for fraud detection using social media according to an embodiment of the disclosure; and

FIG. 5 depicts an example embodiment of a system for fraud detection using social media according to an embodiment of the disclosure.

### DETAILED DESCRIPTION OF THE EMBODIMENTS

The following description is intended to convey a thorough understanding of the embodiments described by providing a number of specific example embodiments and details involving systems and methods for fraud detection using location data derived from social media accounts. It should be appreciated, however, that the present disclosure is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs. A social media system, account provider system, merchant system, and/or account holder device, and system supporting a connection between social media systems, account provider systems, merchant systems, and/or account holder devices, are used as examples for the disclosure. The disclosure is not intended to be limited to social media systems, account provider systems, merchant systems, and/or account holder devices only.

The example embodiments disclosed herein are directed to systems and methods for fraud detection using data derived from social media accounts, and the like. In various embodiments social media data may be derived by a social media application executing on a mobile device. According to the various embodiments of the present disclosure, a social media system may include a system associated with a social media provider, such as Facebook, Twitter, MySpace, Foursquare, Instagram, Google+, LinkedIn, Yelp, and the like. Each social media system may maintain accounts holding account data, such as, for example, subscriber name, subscriber phone number, subscriber address, subscriber email address, subscriber occupation, and/or subscriber location information. Subscriber location information may include updated data received from the subscriber, or another account related to the subscriber, regarding a current location of the subscriber. Subscriber location information may be provided by a mobile device and/or other computing device associated with the subscriber. For example, a subscriber may check-in to a location using the subscriber's mobile device and, for example, a social media application. Also, a subscriber may be checked into a location by an account related to the subscriber using a mobile or other computing device. This check-in may include various location data. The device, in conjunction with the social media application and/or softwareon the mobile device, may then transmit the location data to the social media system, thus updating subscriber location information stored on the social media system. Other methods of transmitting location data may also be used. For example, messages sent using social media platforms may be used to track subscriber location using data, such as metadata, included in the message, where the data is indicative of a location.

According to various embodiments, location data may include, for example, an address, city, state, zip code, county, country, longitude and latitude data, magnetic field data, an IP address, message data indicative of a location, metadata indicative of a location, and/or other forms of data provided via social media indicative of a location.

According to the various embodiments of the present disclosure, a system and method of fraud detection using social media may further include linking a social media account held with the social media system to a financial account held with an account provider system. U.S. patent application Ser. No. 14/031,263 entitled “System and Method for Determining Social Statements,” and U.S. Provisional Patent Application No. 61/737,399 entitled “System and Method for Synching a Financial Account with a Social Network Account,” each disclose systems and methods relating to social media accounts associated with financial accounts, the contents of which are incorporated by reference in their entirety.

Linking the social media system with the account provider system may include receiving, at the social media system, account details of a financial account held at an account provider system and/or receiving, at the account provider system, account details of a subscriber account held at a social media system. The linking process may include an opt-in process. That is to say that a financial account holder may opt-in and allow the financial account provider and associated systems to access data held at a social media system associated with the account holder. Additionally, the social media subscriber may opt-in and allow the social media system to access data held at a financial account provider system associated with the subscriber. The social media subscriber also may opt-in and allow the social media system to provide data to the financial account provider system to enable fraud detection. Data provided by the social media system may include location data and/or social media preference data, including privacy preferences associated with the social media account. Moreover, the linking process may occur through a social linking application programming interface (“API”).

A social linking API may allow certain data to be transmitted through the API so that a social media system may communicate with an account provider system. The social linking API may prevent data other than approved data to be transmitted through the API. For example, the API may only support subscriber name, subscriber e-mail address, subscriber identification information, and/or subscriber location information to be transmitted from the social media system to the account provider system. Also, the social linking API may allow subscriber relationship data to be transmitted to the account provider system if a social media subscriber opts-in to allow relationship data to be provided to the account provider system. For example, relationship data may include data indicative of a group of people, such as family, close friends, and/or colleagues.

By linking the social media system with the account provider system, an account holder authorizes the social media system to transmit subscriber data, such as subscriber location data, from the social media system to the account provider system. In this manner, a multifactor authentication may occur that requires location data received via a social media provider for authentication. A multifactor authentication may take into consideration, along with the social media location data, for example, merchant location data, account holder home location data, and/or account holder preferences.

As used herein a “subscriber” may be one associated with a social media system and an “account holder” may be one associated with a financial account provider system. The account provider system may store the subscriber location data and associate the subscriber location data with the account holder having the linked social media subscriber account.

The account provider system may include a fraud detection module that operates various fraud detection algorithms. For example, a fraud detection algorithm may include an algorithm that determines whether a transaction occurs within a predetermined distance from a location associated with the financial account holder. Fraud detection algorithms also may take into consideration a number of additional variables including, for example, transaction time of day, distance from previous transaction, transaction amount, a merchant associated with the transaction, and/or social media preference data. Each of these variables may be user-defined, defined by the account provider system, and/or defined by the social media system. For example, a user may define a distance radius from a home address such that a transaction occurring outside the user-defined radius may be flagged as fraudulent. In another example, a user may define a distance from a previous transaction and a time between transactions to flag a transaction as fraudulent. In this example, a user may define the distance between transactions as 20 miles and the time between transactions as 10 minutes such that where a transaction occurs more than 20 miles from the previous transaction and under 10 minutes from the previous transaction, the subsequent transaction may be flagged as fraudulent. U.S. Provisional Patent Application No. 61/789,858 entitled “System and Method for Fraud Management,” discloses further fraud management methods, the contents of which are incorporated by reference in their entirety. Additionally, U.S. Pat. No. 7,857,212, entitled “Method and system for authorizing card account transactions by geographic region,” discloses fraud prevention using authorizations by geographic region, the contents of which are incorporated by reference in their entirety.

The system of fraud detection using location data derived from a social media platform may, in addition to determining a distance from a home location, determine whether a transaction occurs within a predetermined distance of social media subscriber location information. A fraud detection algorithm executed at a financial account provider system may consider the time and date associated with the received subscriber current location information. Accordingly, a fraud detection algorithm may proceed with a more aggressive fraud detection algorithm when subscriber location information shows subscriber location data received at a date and/or time higher than a threshold date and/or time. For example, a threshold date and/or time may be one week prior to the current date, two days prior to the current date, twenty-four hours prior to the current time, and the like. Accordingly, when updated subscriber location data has not been received with in the threshold date and/or time, a more aggressive fraud algorithm may be executed. For example, a more aggressive fraud algorithm may use lower threshold triggers, such as for example, a lower distance measurements between subscriber location data and location data associated with a transaction in determining whether the distance measurement is too high to trigger a fraud alert. Additionally, a more aggressive fraud algorithm may consider other factors associated with the merchant and/or account holder. Factors associated with a merchant that may be used in a more aggressive fraud algorithm may include, for example, a fraud rating, a transaction amount, a transaction time and/or date, a merchant type, and/or merchant social media rating (e.g., a Yelp rating, a Google+ rating, etc.). Factors associated with an account holder that may be used in a more aggressive fraud algorithm may include, for example, recent transactions associated with the account holder, an account holder fraud rating, recent location data including date and/or time of location data associated with a linked social media account.

A fraud detection algorithm may proceed with a less aggressive fraud detection algorithm when a subscriber location information illustrates that subscriber location data is received at a date and/or time below or within a threshold date and/or time. For example, a less aggressive algorithm may not take account for or consider at least some of the factors associated with the merchant and/or account holder. Less aggressive algorithms also may provide a higher threshold for fraud triggers (e.g., a higher distance threshold when comparing transaction location to subscriber location data).

A fraud detection module also may receive linked account information. For example, where an account provider system maintains accounts, an account may be associated with multiple joint account holders, each account holder may opt-in to link his or her social media subscriber account to the joint financial account. Moreover, each account holder and the associated account holder transaction card may be separate or combined with the other account holder transaction cards. Where an account holder associated with a joint account opts to keep account holder and social media subscriber data separate, the account provider system may treat the joint account as a private account held by the account holder. Where an account holder associated with a joint account opts to share account holder and/or social media subscriber data with other account holders of the joint account, the account provider may share account holder and/or social media subscriber data. Additionally, one account holder associated with a joint account may be the owner of the account and may set the opt-in preferences for the joint account. For example, where a parent and a child share a joint account and the parent is the owner of the account, the parent may choose to have all child and parent social media subscriber data and account holder data linked or shared within the account provider system. In this example, where a device associated with the child account holder sends location information to a social media system, which then transmits the location information to the account provider system, the parent account holder may receive a notification, a confirmation request, an approval request, and/or a fraud alert.

The account provider system also may include a rewards/deals module that is configured to provide rewards and/or deals associated with activity provided by the social media system. For example, where the account provider system receives location data associated with an account holder location from a social media system, the rewards/deals module may present rewards and/or deals to the account holder for use in a location associated with the received location data. The rewards/deals module may provide rewards and/or deals available for a predetermined time after receiving location data associated with an account holder from a social media system. In this manner, an account holder may have a deal available even after travel is complete.

The account provider system also may include a confirmation module. A confirmation module may provide confirmation data associated with received location data and/or received transaction data. Confirmation data may include, for example, data received from a device associated with the account hold that confirms received location data or received transaction data. Confirmation data also may include data from previous purchases made with an account held at the account provider system or a third party account provider system. For example, where location data is received from a social media subscriber account associated with an account holder, and the account holder is unable to use an account holder device at the location associated with the location data to confirm the location (e.g., where location data includes a foreign country), the account provider may receive and/or search account holder records held at the account provider system or a third party account provider system for lodging and/or transportation providers associated with the received location data. Accordingly, the account provider may verify that transaction data illustrates recently purchased transportation and/or lodging associated with the received location data.

The determination of whether a transaction is recent may be based on a predefined threshold recent date and/or time, such as a transaction made within a certain amount of months, weeks, or days, is considered recent. The transaction data may include data indicative of a date of use associated with the lodging and/or transportation-related transaction. For example, a purchased flight may include the date of flight in the transaction data.

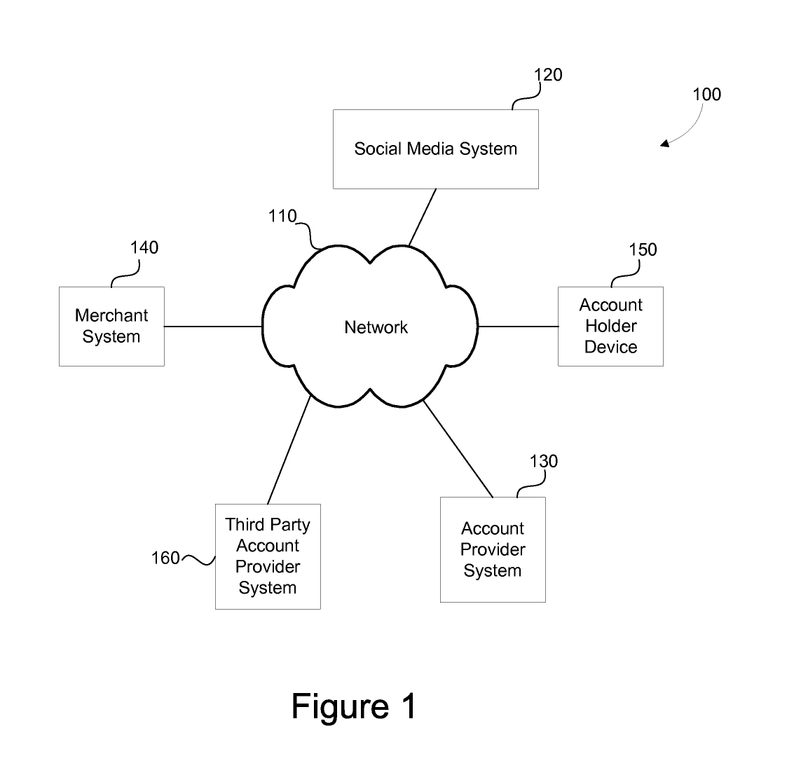

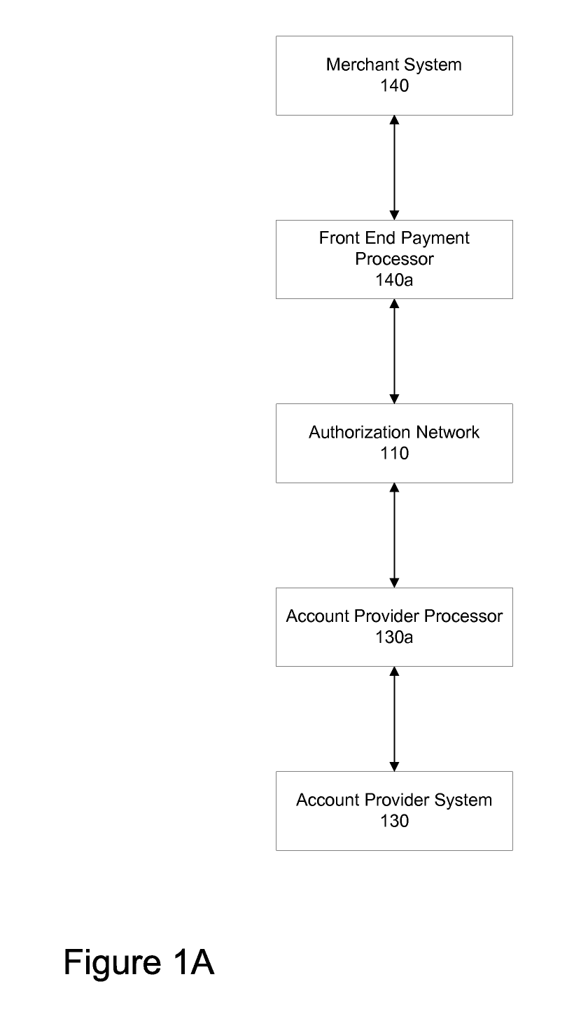

FIG. 1 depicts an example embodiment of a system for fraud detection using social media platforms 100. The system 100 may include various systems connected to each other by a network 110. These systems may include a social media system 120, an account provider system 130, a merchant system 140, an account holder device 150, and a third party account provider system 160.

The network 110 may be one or more of a wireless network, a wired network, or any combination of a wireless network and a wired network. For example, network 110 may include one or more of a fiber optics network, a passive optical network, a cable network, an Internet network, a satellite network, a wireless LAN, a Global System for Mobile Communication (GSM), a Personal Communication Service (PCS), a Personal Area Networks, (PAN), D-AMPS, Wi-Fi, Fixed Wireless Data, IEEE 802.11b, 802.15.1, 802.11n, and 802.11g or any other wired or wireless network for transmitting and receiving a data signal.

In addition, network 110 may include, without limitation, telephone lines, fiber optics, IEEE Ethernet 902.3, a wide area network (WAN), a local area network (LAN) or a global network such as the Internet. Also, network 110 may support an Internet network, a wireless communication network, a cellular network, or the like, or any combination thereof. Network 110 may further include one network, or any number of example types of networks mentioned above, operating as a stand-alone network or in cooperation with each other. Network 110 may utilize one or more protocols of one or more network elements to which they are communicatively couples. Network 110 may translate to or from other protocols to one or more protocols of network devices. Although network 110 is depicted as a single network, it should be appreciated that according to one or more embodiments, network 110 may comprise a plurality of interconnected networks, such as, for example, the Internet, a service provider's network, a cable television network, corporate networks, and home networks.

As illustrated in FIG. 1A for example, network 110 may include an authorization network 110 to allow a merchant 140 to submit payment authorization requests and process payments. An authorization network 110 may be used to communicate payment requests from a merchant system 140 to an issuing financial institution or account provider 130 as well as payment determinations from the issuing financial institution or account provider 130 to the merchant system 140. In communicated payment requests, a merchant payment processing system 140 may pass transaction information, which includes payment information, to a front-end payment processor 140a that maintains connections with a variety of networks 110 connected to financial institutions or account providers 130, such as card associations, banking institutions, and other settlement service providers. The front-end payment processor may pass along the transaction information to the appropriate network 110, which may then route the transaction information to the issuing financial institution or account provider processor (or a back-end payment processor) 130a. The issuing financial institution or account provider processor 130a may check the payment and transaction details in order to approve (or deny) payment. This may include a fraud detection algorithm. The issuing financial institution or account provider 130 may concurrently verify a payment for the received transaction information. The verification of payment (or denial of payment) may then be sent from the issuing financial institution or account provider 130 via the issuing financial institution or account provider processor 130a through the authorization network 110 and front-end processor 140a to the merchant system 140.

The authorization system illustrated in FIG. 1A may be used to both perform real-time authorization as well as batch payment processing. In a batch payment processing system, the issuing financial institution or account provider processor 130a may perform a payment authorization in real-time and then subsequently process the payment at the issuing financial institution or account provider 130 in batch processing.

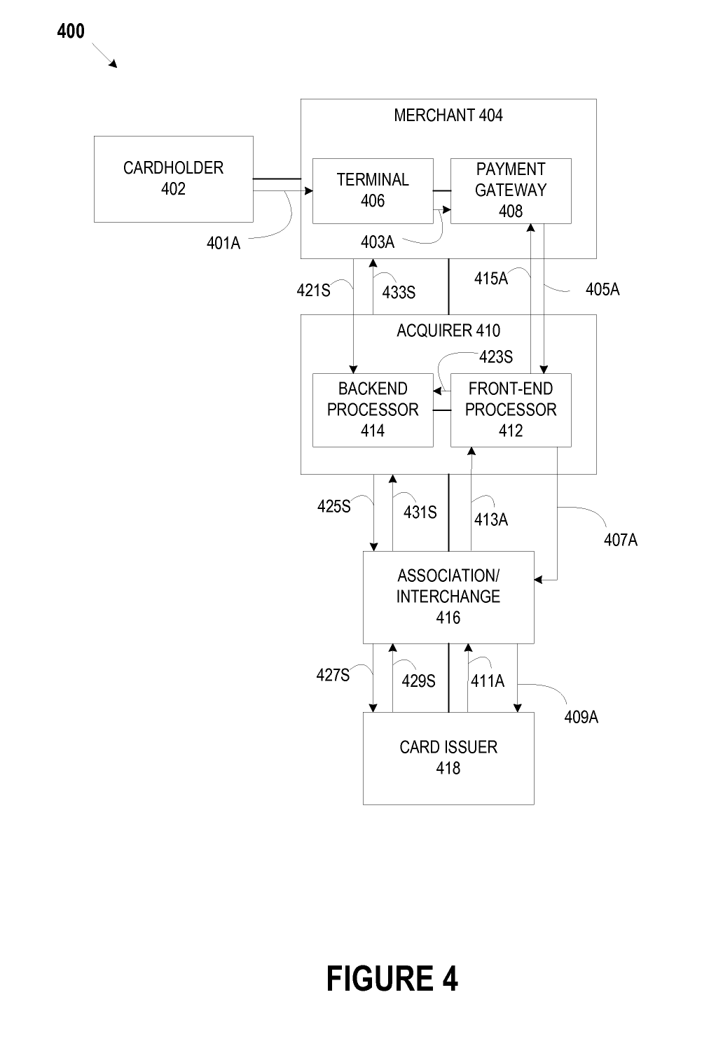

FIG. 4 illustrates an example system 400 and method for card authorization. As shown and described in FIG. 4, merchants, cardholders and financial institutions may be connected with a card association network to enable secure transactions and timely payments. System 400 may include a cardholder 402, merchant 404, Acquirer 410, Association/Interchange 416, and card issuer 418.

Cardholder 402 may be any card holder, including a credit card holder, debit card holder, stored value card holder and the like. Cardholder 402 may possess a plastic card or carry a device (e.g., a mobile device) that securely stores card credentials and is capable of transmitting the card credentials to, for example, a PoS terminal (e.g., terminal 406). Cardholder 402 may interact with a merchant (e.g., merchant 404) by presenting a card or card credentials to a terminal (e.g., terminal 406).

Merchant 404 may be any merchant that accepts payment from a cardholder, for example. Merchant 404 may be any retailer, service provider, business entity, or individual that accepts payments. Merchant 404 may include software, firmware and hardware for accepting and/or processing payments. For example, as illustrated in FIG. 4, merchant 404 may include a terminal 406 and a payment gateway 408. Terminal 406 and payment gateway 408 may comprise the physical or virtual device(s) used by merchant 404 to communicate information to front-end processor 412 of acquirer 410. Terminal 406 may be similar to PoS system [Y00] as shown and described in Figure Y. In various embodiments, payment gateway 408 may be an e-commerce application service provider service that authorizes payments for merchants. As such, payment gateway 408 may be a virtual equivalent of a PoS terminal and interface with, for example, a billing system of merchant 404 and pass data to front-end processor 412 of acquirer 410.

Acquirer 410 may be, for example, a financial institution or bank, that holds the contract for providing payment processing services to merchant 404. Merchant 404 may have a merchant account that may serve as a contract under which Acquirer 410 may extend a line of credit to a merchant who wishes to accept, for example, credit card transactions. As shown in FIG. 4, Acquirer 410 may be associated with front-end processor 412 and back-end processor 414.

In various examples, front-end processor 412 may be a platform that card terminal 406 and/or payment gateway 408 communicate with when approving a transaction. Front-end processor 412 may include hardware, firmware, and software to process transactions. Front-end processor 412 may be responsible for the authorization and capture portion of credit card transaction. Front-end processor 412 also may include additional front-end platform interconnections to support, for example, ACH and debit transactions.

Backend processor 414 may be a platform that takes captured transactions from front-end processor 412 and settles them through an Interchange system (e.g., association/interchange 416). Back-end processor 414 may generate, for example, daily ACH files for merchant settlement. Back-end processor 414 also may handle chargeback handling, retrieval request and monthly statements.

Association/interchange 416 may be the consumer payment system whose members are the financial institutions that issue payment cards and/or sign merchant to accept payment cards. Example associations/interchanges 416 may include, Visa®, MasterCard®, and AmericanExpress®. Association/interchange 416 may include one or more computer systems and networks to process transactions.

Issuer 418 may be a financial institution that issues payment cards and maintains a contract with cardholders for repayment. In various embodiments, issuer 418 may issue credit, debit, and/or stored value cards, for example. Example issuers may include, Capital One, Bank of America, Citibank, and the like.

In various embodiments, processing a payment card transaction may involves two stages: (1) authorization and (2) clearing and settlement. Authorization may refer to an electronic request that is sent through various parties to either approve or decline the transaction. Clearing and Settlement may refer to settlement of the parties' settle accounts to enable the parties to get paid.

During authorization, cardholder 402 may present payment card as payment (401A) at merchant 404 PoS terminal 406, for example. Merchant 404 may enter card into a physical PoS terminal 406 or submit a credit card transaction to a payment gateway 408 on behalf of cardholder 402 via secure connection from a Web site, retail location, or a wireless device.

Payment gateway 408 may receive the secure transaction information (403A) and may pass the secure transaction information (405A) via a secure connection to the merchant acquirer's 410 front-end processor 412.

Front-end processor 412 may submit the transaction (407A) to association/interchange 416 (e.g., a network of financial entities that communicate to manage the processing, clearing and settlement of credit card transactions). Association/interchange 416 may route the transaction (409A) to the customer's Issuer 418. Issuer 418 may approve or decline the transaction and passes the transaction results back (411A) through association/interchange 416. Association/interchange then may relay the transaction results (413A) to front-end processor 412.

Front-end processor 412 may relay the transaction results (415A) back to the payment gateway 408 and/or terminal 406. Payment gateway 408 may store the transaction results and sends them to merchant 404. Merchant 404 may receive the authorization response and complete the transaction accordingly.

During settlement, merchant 404 may deposit the transaction receipt (421S) with acquirer 410 via, for example, a settlement batch. Captured authorizations may be passed (423S) from front-end processor 412 to the back-end processor 414 for settlement. Back-end processor may generates ACH files for merchant settlement. Acquirer may submit settlement files (425S, 427S) to Issuer 418 for reimbursement via association/interchange 416. Issuer 418 may post the transaction and pay merchant 404 (429S, 431S, 433S).

Referring back to FIG. 1, a social media provider may access network 110 through one or more social media systems 120 that may be communicatively coupled to the network 110. An account provider, such as a financial institution, may access the network 110 through one or more account providers systems 130 that may be communicatively coupled to the network 110. One or more merchants may access the network 110 through one or more merchant systems 140 that also may be communicatively coupled to the network 110. Additionally, one or more account holders may be communicatively coupled to the network 110 through an account holder device 150. One or more third party account providers may access the network 110 through a third party account provider system 160. Although mobile social media system 120, account provider system 130, merchant system 140, account holder device 150, and third party account provider system 160 are depicted as a single systems and/or devices, it should be appreciated that according to one or more embodiments, mobile social media system 120, account provider system 130, merchant system 140, account holder device 150, and third party account provider system 160 may comprise a plurality of systems and/or devices.

An example mobile social media system 120, account provider system 130, merchant system 140, account holder device 150, and/or third party account provider system 160 may include one or more network-enabled computers to process instructions for methods of fraud detection using social media data 300. As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the example system 100 may execute one or more software applications for methods of fraud detection using social media data.

The mobile social media system 120, account provider system 130, merchant system 140, account holder device 150, and/or third party account provider system 160 may further include, for example, a processor, which may be several processors, a single processor, or a single device having multiple processors. The application store system 120, vendor system 130, competitor system 140, developer system 150, and mobile application user 160 may access and be communicatively coupled to the network 110. The a mobile social media system 120, account provider system 130, merchant system 140, account holder device 150, and/or third party account provider system 160 may store information in various electronic storage media, such as, for example, a database (not shown) and/or other data storage. Electronic information may be stored in the application mobile social media system 120, account provider system 130, merchant system 140, account holder device 150, and/or third party account provider system 160 in a format such as, for example, a flat file, an indexed file, a hierarchical database, a post-relational database, a relational database, such as a database created and maintained with software from, for example Oracle® Corporation, Microsoft® Excel file, Microsoft® Access file, or any other storage mechanism.

The mobile social media system 120, account provider system 130, merchant system 140, account holder device 150, and/or third party account provider system 160 may send and receive data using one or more protocols. For example, data may be transmitted and received using Wireless Application Protocol (WAP), Multimedia Messaging Service (MMS), Enhanced Messaging Service (EMS), Short Message Service (SMS), Global System for Mobile Communications (GSM) based systems, Time Division Multiplexing (TDM) based systems, Code Division Multiples Access (CDMA) based systems suitable for transmitting and receiving data. Data may be transmitted and received wirelessly or may utilize cabled network connections or telecom connections, fiber connections, traditional phone wireline connection, a cable connection, or other wired network connection.

Each mobile social media system 120, account provider system 130, merchant system 140, account holder device 150, and/or third party account provider system 160 of FIG. 1 also may be equipped with physical media, such as, but not limited to, a compact disc (CD), a digital versatile disc (DVD), a floppy disk, a hard drive, read only memory (ROM), random access memory (RAM), as well as other physical media capable of storing software, or combinations thereof. Mobile social media system 120, account provider system 130, merchant system 140, account holder device 150, and/or third party account provider system 160 may be able to perform the functions associated with methods of fraud detection using social media data. Mobile social media system 120, account provider system 130, merchant system 140, account holder device 150, and/or third party account provider system 160 may, for example, house the software for methods of fraud detection using social media data, obviating the need for a separate device on the network 110 to run the methods housed on Mobile social media system 120, account provider system 130, merchant system 140, account holder device 150, and/or third party account provider system 160.

Furthermore, the information stored in a database (not shown) may be available over the network 110, with the network containing data storage. A database housed on mobile social media system 120, account provider system 130, merchant system 140, account holder device 150, and/or third party account provider system 160 or the network 110, may store, or may connect to external data warehouses that stores, account holder data, social media subscriber data, third party account data, deals and/or rewards data, and/or transaction data.

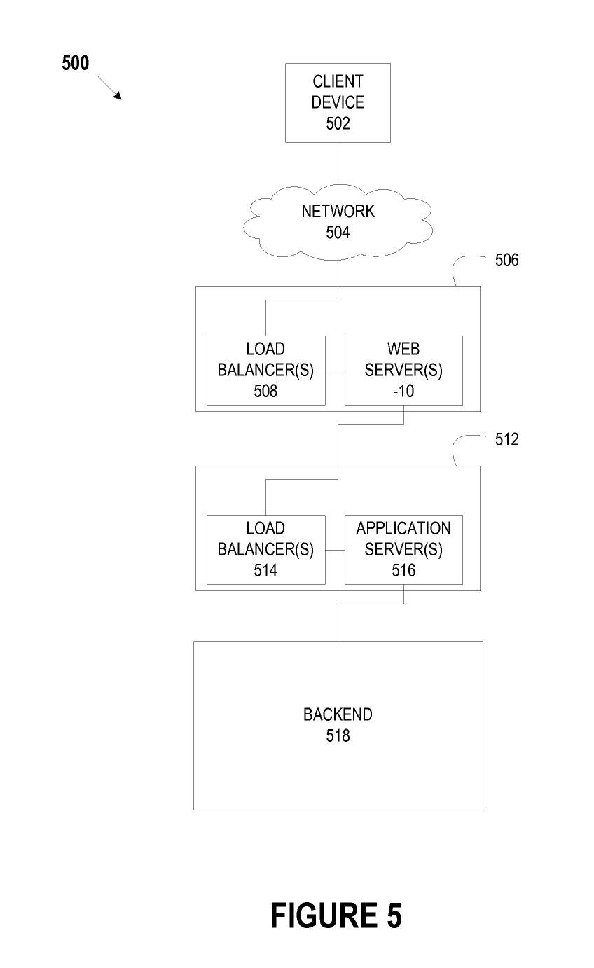

FIG. 5 depicts an example system 500 that may enable a financial institution, for example, to provide network services to its customers. As shown in FIG. 5, system 500 may include a client device 502, a network 504, a front-end controlled domain 506, a back-end controlled domain 512, and a backend 518. Front-end controlled domain 506 may include one or more load balancers 508 and one or more web servers 510. Back-end controlled domain 512 may include one or more load balancers 514 and one or more application servers 516.

Client device 502 may be a network-enabled computer: As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the example system 500 may execute one or more software applications to enable, for example, network communications.

Client device 502 also may be a mobile device: For example, a mobile device may include an iPhone, iPod, iPad from Apple® or any other mobile device running Apple's iOS operating system, any device running Google's Android® operating system, including for example, Google's wearable device, Google Glass, any device running Microsoft's Windows® Mobile operating system, and/or any other smartphone or like wearable mobile device.

Network 504 may be one or more of a wireless network, a wired network, or any combination of a wireless network and a wired network. For example, network 504 may include one or more of a fiber optics network, a passive optical network, a cable network, an Internet network, a satellite network, a wireless LAN, a Global System for Mobile Communication (GSM), a Personal Communication Service (PCS), a Personal Area Networks, (PAN), D-AMPS, Wi-Fi, Fixed Wireless Data, IEEE 802.11b, 802.15.1, 802.11n, and 802.11g or any other wired or wireless network for transmitting and receiving a data signal.

In addition, network 504 may include, without limitation, telephone lines, fiber optics, IEEE Ethernet 902.3, a wide area network (WAN), a local area network (LAN) or a global network such as the Internet. Also, network 504 may support an Internet network, a wireless communication network, a cellular network, or the like, or any combination thereof. Network 504 may further include one network, or any number of example types of networks mentioned above, operating as a stand-alone network or in cooperation with each other. Network 504 may utilize one or more protocols of one or more network elements to which they are communicatively couples. Network 504 may translate to or from other protocols to one or more protocols of network devices. Although network 504 is depicted as a single network, it should be appreciated that according to one or more embodiments, network 504 may comprise a plurality of interconnected networks, such as, for example, the Internet, a service provider's network, a cable television network, corporate networks, and home networks.

Front-end controlled domain 506 may be implemented to provide security for backend 518. Load balancer(s) 508 may distribute workloads across multiple computing resources, such as, for example computers, a computer cluster, network links, central processing units or disk drives. In various embodiments, load balancer(s) 510 may distribute workloads across, for example, web server(S) 516 and/or backend 518 systems. Load balancing aims to optimize resource use, maximize throughput, minimize response time, and avoid overload of any one of the resources. Using multiple components with load balancing instead of a single component may increase reliability through redundancy. Load balancing is usually provided by dedicated software or hardware, such as a multilayer switch or a Domain Name System (DNS) server process.

Load balancer(s) 508 may include software that monitoring the port where external clients, such as, for example, client device 502, connect to access various services of a financial institution, for example. Load balancer(s) 508 may forward requests to one of the application servers 516 and/or backend 518 servers, which may then reply to load balancer 508. This may allow load balancer(s) 508 to reply to client device 502 without client device 502 ever knowing about the internal separation of functions. It also may prevent client devices from contacting backend servers directly, which may have security benefits by hiding the structure of the internal network and preventing attacks on backend 518 or unrelated services running on other ports, for example.

A variety of scheduling algorithms may be used by load balancer(s) 508 to determine which backend server to send a request to. Simple algorithms may include, for example, random choice or round robin. Load balancers 508 also may account for additional factors, such as a server's reported load, recent response times, up/down status (determined by a monitoring poll of some kind), number of active connections, geographic location, capabilities, or how much traffic it has recently been assigned.

Load balancers 508 may be implemented in hardware and/or software. Load balancer(s) 508 may implement numerous features, including, without limitation: asymmetric loading; Priority activation: SSL Offload and Acceleration; Distributed Denial of Service (DDoS) attack protection; HTTP compression; TCP offloading; TCP buffering; direct server return; health checking; HTTP caching; content filtering; HTTP security; priority queuing; rate shaping; content-aware switching; client authentication; programmatic traffic manipulation; firewall; intrusion prevention systems.

Web server(s) 510 may include hardware (e.g., one or more computers) and/or software (e.g., one or more applications) that deliver web content that can be accessed by, for example a client device (e.g., client device 502) through a network (e.g., network 504), such as the Internet. In various examples, web servers, may deliver web pages, relating to, for example, online banking applications and the like, to clients (e.g., client device 502). Web server(s) 510 may use, for example, a hypertext transfer protocol (HTTP or sHTTP) to communicate with client device 502. The web pages delivered to client device may include, for example, HTML documents, which may include images, style sheets and scripts in addition to text content.

A user agent, such as, for example, a web browser, web crawler, or native mobile application, may initiate communication by making a request for a specific resource using HTTP and web server 510 may respond with the content of that resource or an error message if unable to do so. The resource may be, for example a file on stored on backend 518. Web server(s) 510 also may enable or facilitate receiving content from client device 502 so client device AO2 may be able to, for example, submit web forms, including uploading of files.

Web server(s) also may support server-side scripting using, for example, Active Server Pages (ASP), PHP, or other scripting languages. Accordingly, the behavior of web server(s) 510 can be scripted in separate files, while the actual server software remains unchanged.

Load balancers 514 may be similar to load balancers 508 as described above.

Application server(s) 516 may include hardware and/or software that is dedicated to the efficient execution of procedures (e.g., programs, routines, scripts) for supporting its applied applications. Application server(s) 516 may comprise one or more application server frameworks, including, for example, Java application servers (e.g., Java platform, Enterprise Edition (Java EE), the .NET framework from Microsoft®, PHP application servers, and the like). The various application server frameworks may contain a comprehensive service layer model. Also, application server(s) 516 may act as a set of components accessible to, for example, a financial institution or other entity implementing system 500, through an API defined by the platform itself. For Web applications, these components may be performed in, for example, the same running environment as web server(s) 510, and application servers 516 may support the construction of dynamic pages. Application server(s) 516 also may implement services, such as, for example, clustering, fail-over, and load-balancing. In various embodiments, where application server(s) 516 are Java application servers, the web server(s) 516 may behaves like an extended virtual machine for running applications, transparently handling connections to databases associated with backend 518 on one side, and, connections to the Web client (e.g., client device 502) on the other.

Backend 518 may include hardware and/or software that enables the backend services of, for example, a financial institution or other entity that maintains a distributes system similar to system 500. For example, backend 518 may include, a system of record, online banking applications, a rewards platform, a payments platform, a lending platform, including the various services associated with, for example, auto and home lending platforms, a statement processing platform, one or more platforms that provide mobile services, one or more platforms that provide online services, a card provisioning platform, a general ledger system, and the like. Backend 518 may be associated with various databases, including account databases that maintain, for example, customer account information, product databases that maintain information about products and services available to customers, content databases that store content associated with, for example, a financial institution, and the like. Backend 518 also may be associated with one or more servers that enable the various services provided by system 500.

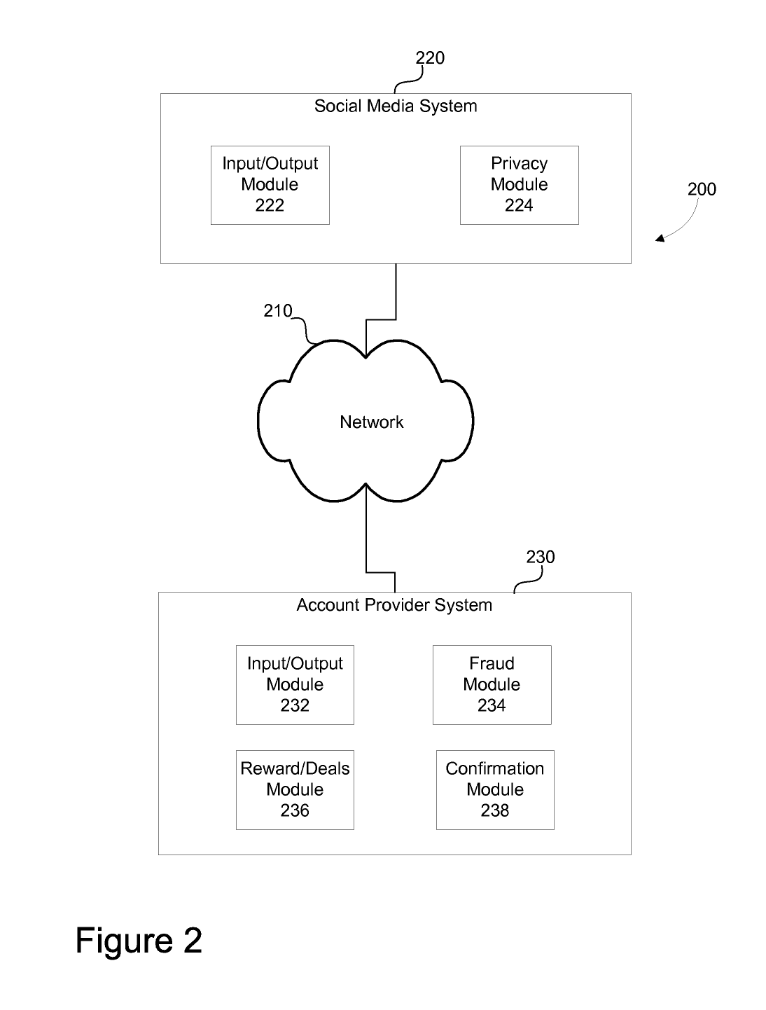

Referring now to FIG. 2, FIG. 2 illustrates various modules used in, for example, a social media system 220, which may be similar to social media system 130, and an account provider system 230, which may be similar to account provider system 130. As used herein, the term “module” may be understood to refer to computer executable software, firmware, hardware, or various combinations thereof. It is noted that the modules are exemplary. The modules may be combined, integrated, separated, or duplicated to support various applications. Also, a function described herein as being performed at a particular module may be performed at one or more other modules and by one or more other devices instead of or in addition to the function performed at the particular module. Further, the modules may be implemented across multiple devices or other components local or remote to one another. Additionally, the modules may be moved from one device and added to another device, or may be included in both devices.

Social media system 220 may include an input/output module 222 and a privacy module 224. The input/output module 222 may include various hardware and software components, such as, for example, a repeater, a microwave antenna, a cellular tower, or another network access device capable of providing connectivity between network mediums. The input/output module may also contain various software and/or hardware components to enable communication over a network 210. For example, the input/output module 222 may be capable of sending or receiving signals via network 210. Moreover, the input/output module 222 may provide connectivity to one or more wired networks and may be capable of receiving signals on one medium such as a wired network and transmitting the received signals on a second medium such as a wireless network.

Privacy module 224 may include various hardware and software components, such as for example, data storage and at least one processor, capable of providing privacy features associated with a social media system 220. Privacy module 224 also may provide functionality associated with filtering social media data from social media system 220 so that only relevant data is transmitted from the social media system 220 via the input/output module 222. For example, privacy module 224 may provide the functionality to allow a social media subscriber to opt into a fraud alert service associated with an account provider system 230. Where a subscriber opts into a fraud alert service, privacy module 224 may filter subscriber data so that only relevant and/or required subscriber data is provided to an account provider system 230, in accordance with a social media system and/or account provider system privacy policy. Relevant and/or required data may include subscriber identifying information, location information, such as a received location data, the subscriber who provided the received location data, the date and timestamp associated with the received location data, and/or privacy data associated with the subscriber account. Privacy data associated with the subscriber account may include, for example, data indicative of whether a subscriber allows other social media subscribers to provide location data relating to the subscriber (e.g., a friend “checks in” to a location and tags the subscriber in the post as also being at the location, a family member uploads a picture with time/date and location information and tags the subscriber in the picture, etc.). Privacy data associated with a subscriber account also may include a list of additional subscribers that are authorized to provide location data for the subscriber and/or approval data associated with location data for the subscriber (e.g., whether the subscriber requires approval of location data provided by a friend, relative, colleague, or the like; whether the subscriber has provided the required approval data; etc.).

Account provider system 230 may include an input/output module 232, a fraud module 234, a rewards/deals module 236, and a confirmation module 238. The input/output module 232 may include various hardware and software components, such as, for example, a repeater, a microwave antenna, a cellular tower, or another network access device capable of providing connectivity between network mediums. The input/output module may also contain various software and/or hardware components to enable communication over a network 210. For example, the input/output module 232 may be capable of sending or receiving signals via network 210. Moreover, the input/output module 232 may provide connectivity to one or more wired networks and may be capable of receiving signals on one medium such as a wired network and transmitting the received signals on a second medium such as a wireless network.

Fraud module 234 may include various hardware and software components to perform methods for fraud detection using social media data received via the input/output module 232. Fraud module 234 also may include various data storage hardware and software components as described above in order to store received social media data for current and future fraud detection algorithms. Fraud module 234 may access a social media API in order to request and/or receive data from social media system 220. For example, fraud module 234 may receive data indicative of a transaction request from a merchant. Fraud module 234 may then retrieve stored social media data and/or request social media data from a social media system 220. Accordingly, account provider systems 230 may not be required to store social media data, but instead may access social media data upon receiving data indicative of a transaction request. Social media data may include location information and/or privacy information associated with the social media system 220. Fraud module 234 also may use a social media API to request social media data from a social media system 220 and store the requested social media data on the account provider system 230. Fraud module 234 may utilize the social media API to perform these requests at predetermined intervals, such as, for example, daily, on certain days of the week, weekly, or any other predetermined interval.

Fraud module 234 also may perform a fraud analysis using fraud detection algorithms. For example, a fraud detection algorithm may include an algorithm that determines if a transaction occurs within a predetermined distance from a location associated with the financial account holder, where the location associated with the financial account holder includes subscriber location information obtained from a social media system 220 via a social media API.

Fraud detection algorithms also may take into consideration, transaction time of day, distance from previous transaction, transaction amount, a merchant associated with the transaction, and/or privacy information associated with the social media subscriber. A fraud detection algorithm executed at a financial account provider system may take into consideration the time and/or date associated with the received subscriber current location information. Accordingly, a fraud detection algorithm may proceed with a more aggressive fraud detection algorithm when subscriber location information shows subscriber location data received at a date and/or time higher than a threshold date and/or time. For example, a threshold date and/or time may be one week prior to the current date, two days prior to the current date, twenty-four hours prior to the current time, and the like. A fraud detection algorithm may proceed with a less aggressive fraud detection algorithm when subscriber location information illustrates that subscriber location data is received at a date and/or time below a threshold date and/or time.

As discussed herein, fraud detection module 234 also may receive linked account information, such as a joint account held by two account holders. In this manner each account holders' social media data may be relevant for fraud detection algorithms. Where an account holder associated with a joint account opts to share account holder and/or social media subscriber data with other account holders of the joint account, the account provider may share account holder and/or social media subscriber data. Additionally, one account holder associated with a joint account may be the owner of the account and may set the opt-in preferences for the joint account. For example, where two people share a joint account and a first person is the owner of the account, the first person may choose to have both account holders' social media subscriber data and account holder data shared within the account provider system. In this example, where a device associated with the second account holder sends location information to a social media system, which then transmits the location information to the account provider system, the first account holder and the second account holder may receive a notification, a confirmation request, an approval request, and/or a fraud alert.

Rewards/deals module 236 may include various hardware and software components to provide rewards and/or deals to an account holder based on social media data received through the social media API. Rewards/deals module 236 also may be configured to provide rewards and/or deals to account holders when account holders opt into linking a social media account with the financial account held by the account holder. For example, where the account provider system receives location data associated with an account holder location from a social media system, the rewards/deals module may present rewards and/or deals to the account holder for use in a location associated with the received location data. The rewards/deals module may provide rewards and/or deals available for a predetermined time after receiving location data associated with an account holder from a social media system. In this manner, an account holder may have a deal available even after travel is complete.

Confirmation module 238 may include various hardware and software components to perform methods for confirming data associated with a social media subscriber account and/or a transaction associated with an account held by an account holder. Confirmation module 238 also may utilize a social media API when confirming data associated with social media system 220. Confirmation module 238 may provide confirmation data associated with received location data and/or received transaction data. Confirmation data may include, for example, data received from a device associated with the account holder that confirms received subscriber location data or received transaction location data. Confirmation data also may include data from previous purchases made with an account held at the account provider system or a third party account provider system. For example, where location data is received from a social media subscriber account associated with an account holder, and the account holder is unable to use an account holder device at the location associated with the location data to confirm the location (e.g., where location data includes a foreign country), the account provider may receive and/or search account holder transaction records held at the account provider system 230 or a third party account provider system for lodging and/or transportation providers associated with the received location data. Accordingly, the account provider may verify that account holder transaction data illustrates recently purchased transportation and/or lodging associated with the received location data.

The determination of whether a transaction is recent may be based on a predefined threshold recent date and/or time, such as a transaction made within a certain amount of months, weeks, or days, is considered recent. The transaction data may include data indicative of a date of use associated with the lodging and/or transportation-related transaction. For example, a purchased flight may include the date of flight in the transaction data.

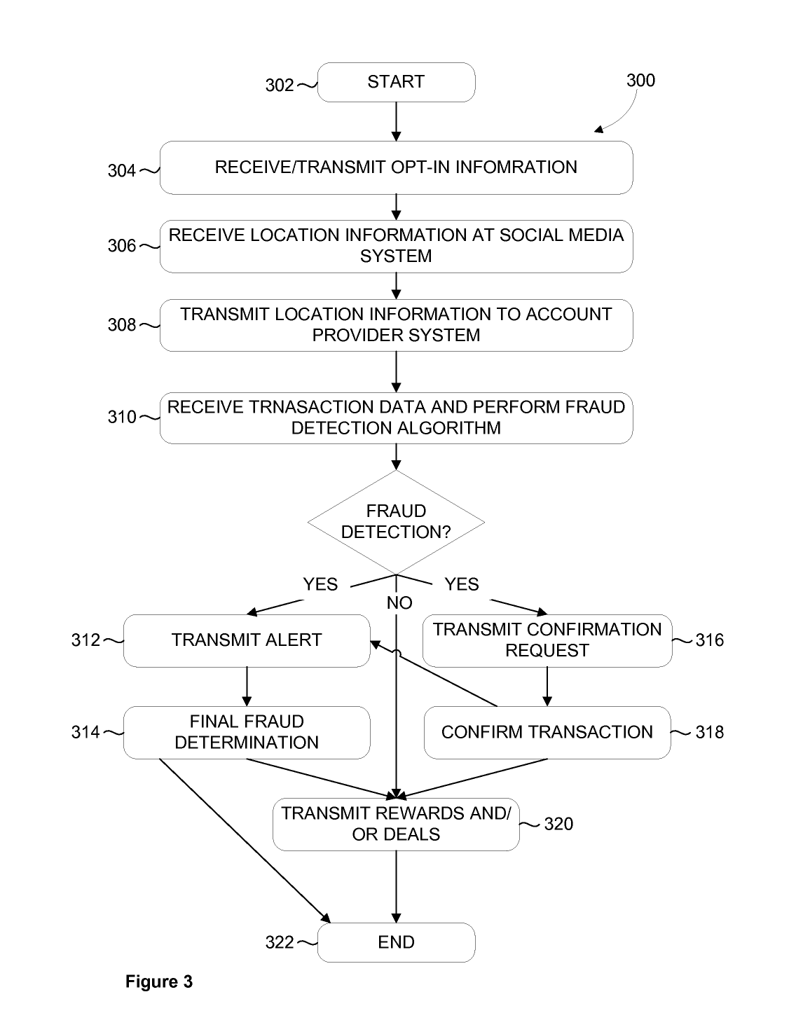

FIG. 3 illustrates a method for fraud detection using location information derived from social media platforms 300. The method 300 may begin at step 302. At step 304, opt-in information may be received at a social media system and/or an account provider system. Opt-in information may include user information, such as a subscriber associated with a social media system and/or an account holder associated with an account provider system as well as privacy information associated with the subscriber and/or account holder. Opt-in information may be obtained by a user logging into a social media and/or an account provider account and selecting that the user allows the social media system and the account provider system to be in communication with one another. Such communication may occur using various input/output modules housed at the account provider system and/or the social media system as well as a social media API that facilitates communication between systems. Where opt-in information is received at a social media system, the social media subscriber may provide account details associated with an account held with account provider. Accordingly, the social media system may transmit opt-in information to the account provider for verification. Similarly, the account holder may opt-in using the account provider system and the account provider system may transmit the optopt-in in information to the social media system for verification. Verification may include providing an alert to the user to verify ownership of the account associated with the subscriber or account holder account. The alert may be sent via email, SMS, MMS, voice calling, voicemail, and/or other forms of communication.

Once a user has linked a social media subscriber account and at least one account held with an account provider, such as a financial institution, the social media system may receive location information from a subscriber. A subscriber may, at step 306, provide location information by, for example, checking into a location, transmitting a picture tagged with location data, transmitting a social message, such as a tweet, post, instant message, email, or the like, that is tagged with location data and/or includes data and/or metadata associated with a location, selecting a location as a current location, transmitting a video tagged with location data and/or includes data and/or metadata associated with a location, and the like. In addition, location information may be provided by a friend, relative, or otherwise associated subscriber connected to the subscriber. For example, the associated subscriber may check into a location and tag the subscriber in the check in. Accordingly, the social media system may correlate the location information from the associate subscriber to the subscriber.

When location information is received from an associate subscriber, subscriber privacy data may be used to determine the authenticity of the location information. For example, a subscriber's privacy information may allow all associate subscriber location data that tags the subscriber to be automatically approved. In this example, the location data and privacy data may indicate a new subscriber location. In another example, a subscriber's privacy information may allow a limited set of associate subscriber location data that tags the subscriber to be automatically approved (e.g., a listing of family member and/or close friends). In this example, where an associate subscriber that is not a member of the limited set provides location information associated with the subscriber, the location information and privacy data may indicate that the location may be fraudulent. A subscriber's privacy information may prohibit associate subscriber location data to be associated with the subscriber and/or require subscriber approval before associate location data is deemed subscriber location data. Accordingly, the varying privacy information may provide an indication of fraudulent activity.

Location information may include, for example, location identifying data, such as, an address, city, state, zip code, county, country, longitude and latitude data, magnetic field data, an IP address, message data indicative of a location, metadata indicative of a location, and/or other forms of data provided via social media indicative of a location. Location information also may include a time and/or date stamp associated with the location identifying data.

At step 308, the location information may be sent to the account provider system. The transmission of the location information may occur at predetermined intervals, such as hourly, daily, weekly, or any other interval. Also, the transmission of location information may occur upon detection of a trigger, such as a transaction request associated with a social media subscriber account linked to the financial account related to the transaction request (step 310).

At step 310, transaction data may be received at the account provider system. Transaction data may be transmitted from a merchant system and may include, for example, merchant name, address, phone number, transaction amount, transaction date and time, and any other transaction and/or merchant identifying information. Once transaction data is received, the account provider system may perform a fraud detection using a fraud detection algorithm.

For example, a fraud detection algorithm may include an algorithm that determines if a transaction occurs within a predetermined distance from the location associated with the financial account holder obtained from the social media system via a social media API. Fraud detection algorithms also may take into consideration, transaction time of day, distance from previous transaction, transaction amount, a merchant associated with the transaction, and/or privacy information associated with the subscriber account. A fraud detection algorithm may take into consideration the time and date associated with the location information received from the social media system. Accordingly, a fraud detection algorithm may proceed with a more aggressive fraud detection algorithm when subscriber location information shows subscriber location data received at a date and/or time higher than a threshold date and/or time.

For example, a threshold date and/or time may be one week prior to the current date, two days prior to the current date, twenty-four hours prior to the current time, and the like. A fraud detection algorithm may proceed with a less aggressive fraud detection algorithm when subscriber location information illustrates that subscriber location data is received at a date and/or time below a threshold date and/or time. Where the account associated with the transaction is a joint account and each account holders information is linked as described above, the fraud detection algorithm may take into consideration location information associated with each account holder.

As an exemplary fraud detection algorithm, the subscriber location data available at time t may be inspected for a date/time stamp and/or a comparison with a subscriber or account holder home address. Where the subscriber location data indicates a location within a predefined distance of the subscriber or account holder home address, the fraud detection algorithm may compare the transaction location at time t with the subscriber location data available at time t. Where the difference between the transaction location at time t and the subscriber location data available at time t is more than a predefined distance threshold, the fraud detection algorithm may indicate potential fraud and the method may proceed to step 312 or step 316.

Where the subscriber location data indicates a location above a predefined distance from the subscriber or account holder home address, the date/time stamp may be examined. A date/time stamp associated with subscriber location data that is over a predefined date/time threshold may indicate that the subscriber location data is not current. Accordingly, when subscriber location data is not current and transaction location data indicates that the transaction is above a predefined distance from a subscriber or account holder's home address, the transaction may be flagged as fraudulent and the method may proceed to step 312 or step 316.

A date/time stamp associated with a subscriber location that is below a predefined date/time threshold may indicate current subscriber location data. Accordingly, the fraud detection algorithm may compare the subscriber location data available at time t with the transaction location data received at time t. A difference between the subscriber location data and the transaction location data at time t that is above a distance threshold may result in a transaction being flagged as fraudulent. The method may then proceed to step 312 or step 316. Where the difference between subscriber location data and transaction location data at time t is below a distance threshold, the fraud detection algorithm may flag a transaction as approved. Other variables also may be considered in a fraud detection algorithm, such as, for example, merchant identification information (e.g., merchant name, merchant address, merchant phone number, merchant ID, and the like) and other transaction information (e.g., transaction amount).

Where a fraud detection algorithm detects fraud, an alert may be transmitted (step 312). For example, an alert may be sent to a device associated with the social media subscriber and/or a device associated with the account holder. The alert may be in the form of email, SMS, MMS, voice call, voicemail, push notifications, and the like. The alert may be sent through the social media API. The alert may provide information associated with the transaction, such as the merchant name, address, telephone, transaction amount, transaction date/time, and the like. The alert may provide information associated with the most recent location data received from the social media subscriber account. Where an account held at an account provider is a joint account an alert may be sent to each account holder associated with the joint account and/or an alert may be transmitted to one account holder, such as the account holder associated with the transaction or the owner of the account.

The user may respond to the alert in order to override the fraud detection determination. Accordingly, at step 314, following a predetermined time after an alert has been transmitted an account holder system may make a final fraud determination. Where an account holder does not respond to an alert overriding a fraud detection, the final fraud determination will result in the account be flagged as having fraudulent activity and the method may end at step 222.

A fraud module at an account provider system also may transmit a confirmation request and utilize a confirmation module when a fraud detection algorithm indicates a fraudulent transaction (step 316). A confirmation module may provide confirmation data associated with a transaction that is indicative of the received subscriber location data and/or received transaction data. Confirmation data may include, for example, data received from a device associated with the account holder or subscriber that confirms received transaction location data. Confirmation data also may include data from previous purchases made with an account held at the account provider system or a third party account provider system. For example, where location data is received from a social media subscriber account associated with an account holder and the account holder is unable to use an account holder device at the location associated with the transaction location data to confirm the transaction location (e.g., where location data includes a foreign country and the account holder/subscriber does not to have access to his or her mobile device), the account provider may receive and/or search account holder transaction records held at the account provider system or a third party account provider system for lodging and/or transportation providers associated with the received location data. Accordingly, the account provider may verify that transaction data housed with the account provider system or third party account provider system illustrates recently purchased transportation and/or lodging associated with the received location data. The determination of whether a transaction is recent may be based on a predefined threshold recent date and/or time, such as a transaction made within a certain amount of months, weeks, or days, is considered recent. The transaction data may include data indicative of a date of use associated with the lodging and/or transportation-related transaction. For example, a purchased flight may include the date of flight in the transaction data.

At step 318, the received transaction flagged as fraudulent may be un-flagged when a confirmation module confirms that the transaction is not fraudulent. Where a confirmation module cannot confirm a transaction is not fraudulent, the method may proceed to step 312 to transmit an alert to the account holder.

Assuming that either the fraud detection algorithm did not detect a fraudulent transaction, the account holder transmitted an alert response to the account provider system to override a determination of fraudulent activity, and/or a confirmation module provided further information to result in a confirmed non-fraudulent transaction, the method may continue and transmit any rewards and/or deals associated with the transaction. Rewards and/or deals may be prepared and transmitted using a rewards and/or deals module. Rewards/deals module may be configured to provide rewards and/or deals to account holders when the account provider system receives location data associated with an account holder location from a social media system. The rewards/deals module may present rewards and/or deals to the account holder for use in a location associated with the received location data. A rewards/deals module may provide rewards and/or deals available for a predetermined time after receiving location data associated with an account holder from a social media system. A rewards/deals module may provide rewards and/or deals available after successfully processing a transaction for an account that has a linked social media subscriber account. In this manner, an account holder may have a deal available even after travel is complete. The method may then end at step 322.

It should be appreciated that the foregoing discussion related to FIGS. 1 through 3 is illustrative only, and that the various embodiments of the disclosure may be implemented by any other appropriate system or method.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

I claim:

1. A system, comprising:
an application programming interface (API) that establishes, via a network, a link between an account provider system and a social media system;
a registration processor that receives, via a network, registration information that indicates that a customer wishes to register for a location-based account service provided by the account provider system, wherein the social media system provides at least a portion of location data used to support the location-based account service provided by the account provider system;
a location processor that receives, via a network, location information from the social media system, wherein the location information is associated with the location of the customer; and
a fraud processor that executes a fraud detection algorithm to determine whether to approve a transaction based in part on the received location information.

2. The system according to claim 1, wherein the location information is based on check-in data provided by the customer to the social media system.

3. The system according to claim 1, wherein the account provider system is associated with a financial institution.

4. The system according to claim 3, wherein the transaction is a credit card transaction.

5. The system according to claim 3, wherein the transaction is a debit card transaction.

6. The system according to claim 3, wherein the transaction is a mobile payment transaction.

7. The system according to claim 1, wherein the location processor receives merchant location information for a merchant that seeks authorization for the transaction.

8. The system according to claim 7, wherein the fraud detection algorithm compares the location information from the social media system with the merchant location information to determine whether to approve the transaction.

9. The system according to claim 8, wherein the fraud detection algorithm approves the transaction if the result of the comparison indicates that the customer is within a threshold distance of the merchant.

10. The system according to claim 9, wherein the fraud detection algorithm denies the transaction if the result of the comparison indicates that the customer is not within a threshold distance of the merchant.

11. A method, comprising:
establishing, via a network using an application programming interface (API), a link between an account provider system and a social media system;
receiving, via a network using a registration processor, registration information that indicates that a customer wishes to register for a location-based account service provided by the account provider system, wherein the social media system provides at least a portion of location data used to support the location-based account service provided by the account provider system;
receiving, via a network using a location processor, location information from the social media system, wherein the location information is associated with the location of the customer; and
executing, using a fraud processor, a fraud detection algorithm to determine whether to approve a transaction based in part on the received location information.

12. The method according to claim 11, wherein the location information is based on check-in data provided by the customer to the social media system.

13. The method according to claim 11, wherein the account provider system is associated with a financial institution.

14. The method according to claim 13, wherein the transaction is a credit card transaction.

15. The method according to claim 3, wherein the transaction is a debit card transaction.

16. The method according to claim 13, wherein the transaction is a mobile payment transaction.

17. The method according to claim 11, further comprising:
receiving, at the location processor, merchant location information for a merchant that seeks authorization for the transaction.

18. The method according to claim 17, wherein the fraud detection algorithm compares the location information from the social media system with the merchant location information to determine whether to approve the transaction.

19. The method according to claim 18, wherein the fraud detection algorithm approves the transaction if the result of the comparison indicates that the customer is within a threshold distance of the merchant.

20. The method according to claim 19, wherein the fraud detection algorithm denies the transaction if the result of the comparison indicates that the customer is not within a threshold distance of the merchant.
